(19) United States
(12) Patent Application Publication
(10) Pub. No.: US 2011/0153923 A1
(43) Pub. Date: Jun. 23, 2011

(54) HIGH SPEED MEMORY SYSTEM

(76) Inventors: Yu-Hsun Peng, Hsinchu County (TW); Jung-Ping Yang, Hsinchu County (TW); Ching-Wen Lai, Hsin-Chu (TW)

(21) Appl. No.: 12/696,066

(22) Filed: Jan. 29, 2010

(30) Foreign Application Priority Data
Dec. 17, 2009 (TW) 098143343

(51) Int. Cl. G06F 12/00; G06F 1/04; G06F 13/14

(52) U.S. Cl. 711/104; 711/167; 713/600; 710/305; 711/E12.001; 710/52

(57) ABSTRACT

A high speed memory system includes a plurality of memory devices; a plurality of buffers; and a memory controller. The plurality of buffers is respectively coupled to the plurality of memory devices. The memory controller is coupled to the plurality of buffers, for generating a plurality of control signal to the plurality of buffers and sequentially controlling access to the plurality of memory devices in a time-sharing manner according to a clock.

### BACKGROUND OF THE INVENTION

1. Field of the Invention

The present invention relates to a high speed memory system, and more particularly, to a high speed memory system combining various sub-memory devices for realizing a high bandwidth memory system.

2. Description of the Prior Art

Static Random Access Memory (SRAM) is a type of semiconductor memory that is able to offer high speed access. SRAM technology is therefore widely applied in many electronic products requiring fast read and/or write speeds, which can be used as a processor cache memory or a register in a graphic chip or a network chip. However, in addition to fast access speed, bandwidth of a memory is another important concern. For example, with the progressively increasing size, resolution, and frame rate of liquid crystal displays, the SRAM used in a graphic chip of a liquid crystal display should provide sufficient image data transmission capability for ensuring whole data transmission. In other words, the SRAM needs to provide more bandwidth for achieving high data transmission efficiency.

One traditional approach to improve the memory bandwidth is to increase the bus width. When bus width of a memory is increased, the memory is able to read (or write) more data at each time. However, as the bus width is varied, the minimum package size which the memory can process is changed. In such a condition, the input/output interface protocol specification will vary with the above bus width variation. As a result, the whole system specification will be affected, causing a system design and manufacturing problem.

In addition, another approach to improve the memory bandwidth is to increase the operation speed of the memory. However, as the operation frequency of the SRAM is increased, the power consumption of the memory also becomes greater, thereby affecting the whole system performance. Also, the operation frequency of a single SRAM is not able to satisfy the requirements due to manufacturing process limitations. Furthermore, for portable electronic products, the most power consumption during stand-by time is the static power consumption of the used SRAM. The power consumption problem of the used SRAM in the static condition is caused by leakage currents. Thus, the driving capability may be reduced in order to reduce the leakage current, but this further affects the operation frequency of the used SRAM. In short, how to determine a method to increase the operation speed of the SRAM for enhancing memory bandwidth in a low static power consumption semiconductor manufacturing process should be a concern in the progressive application design.

### SUMMARY OF THE INVENTION

It is therefore an objective of the present invention to provide a high speed memory system.

The present invention discloses a high speed memory system, which comprises a plurality of memory devices; and a memory controller, coupled to the plurality of memory devices, for sequentially controlling access to the plurality of memory devices in a time-sharing manner according to a clock.

The present invention further discloses a high speed memory system, which comprises a plurality of memory devices; a plurality of buffers, respectively coupled to the plurality of memory devices; and a memory controller, coupled to the plurality of buffers, for generating a plurality of control signals to the plurality of buffers and sequentially controlling access to the plurality of memory devices in a time-sharing manner according to a clock.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a memory system according to a first embodiment of the present invention.

FIG. 2 is a schematic diagram of the memory system having four SRAMs according to an embodiment of the present invention.

FIG. 3 is a schematic diagram of signal waveforms of the memory system shown in FIG. 2 during a writing operation according to an embodiment of the present invention.

FIG. 4 is a schematic diagram of image data configuration of the memory system shown in FIG. 2 according to an embodiment of the present invention.

FIG. 5 is a schematic diagram of a memory system according to a second embodiment of the present invention.

### DETAILED DESCRIPTION

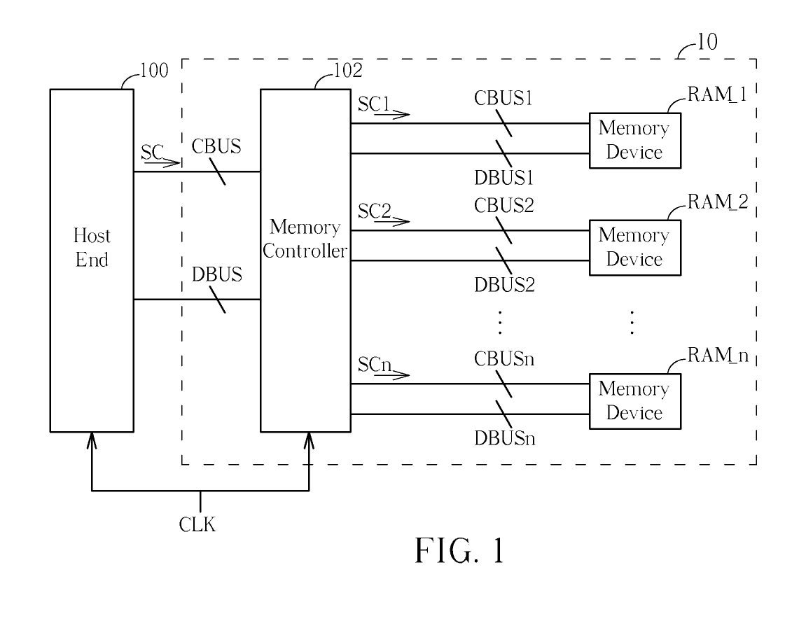

Please refer to FIG. 1, which is a schematic diagram of a memory system 10 according to a first embodiment of the present invention. The memory system 10 includes a memory controller 102, a system control bus CBUS, a system data bus DBUS, memory devices RAM_1˜RAM_n, control buses CBUS_1˜CBUS_n, and data buses DBUS_1˜DBUS_n. Preferably, each of the memory devices RAM_1˜RAM_n can be a static random access memory (SRAM), but this is not a limitation of the present invention. The memory controller 102 is coupled to the system control bus CBUS and the system data bus DBUS. The memory controller 102 is able to receive a system control signal SC and data signals from a host end 100 via the system control bus CBUS and the system data bus DBUS, and transmit data signals obtained from the memory devices RAM_1˜RAM_n to the host end 100. Furthermore, as shown in FIG. 1, the memory controller 102 is also coupled to the memory devices RAM_1˜RAM_n through the control buses CBUS_1˜CBUS_n and the data buses DBUS_1˜DBUS_n, respectively. Each of the system data bus DBUS and the data buses DBUS_1˜DBUS_n has the same data bus width. Each of the system control bus CBUS and control buses CBUS_1˜CBUS_n has the same control bus width.

In the embodiment of the present invention, the memory controller 102 generates control signals SC1˜SCn according to a system clock CLK and the system control signal SC, and accesses the memory devices RAM_1˜RAM_n by turns with a time-sharing manner via the control buses CBUS_1˜CBUS_n and the data buses DBUS_1˜DBUS_n accordingly. In such a condition, each of the memory devices RAM_1˜RAM_n is regarded as an independent memory device and operates with a normal operation frequency. Therefore, the present invention can access the memory devices RAM_1˜RAM_n by turns at different times through the allocation arrangement of the memory controller 102 based on the operation speed of each memory device for meeting a data access requirement of the host end 100. In other words, when the data transmission amount between the host end 100 and the memory controller 102 is greater than the data access amount provided by each memory device, the present invention can combine the memory devices RAM_1˜RAM_n with lower operation speed in a time division multiplexing manner to enhance data bandwidth and system performance for realizing the desired high bandwidth memory access. For example, if the operation frequency of each of the memory devices RAM_1˜RAM_n is A, the total operation frequency of the memory system 10 is n×A. In other words, compared with each memory device, the memory system 10 has a data bandwidth of n times each memory device for high speed data access. When the host end 100 wants to read the data stored in each memory device, the memory controller 102 is capable of generating corresponding control signals SC1˜SCn according to the system clock CLK and the corresponding system control signal SC in order to arrange to read the desired data stored in the corresponding memory device at different times in accordance with an operation frequency of each memory device. In short, the memory controller 102 can arrange various memory devices to perform reading or writing operations at different times according to the system clock CLK, data transmission speed and the operation frequency of each independent memory device for realizing high speed memory access.

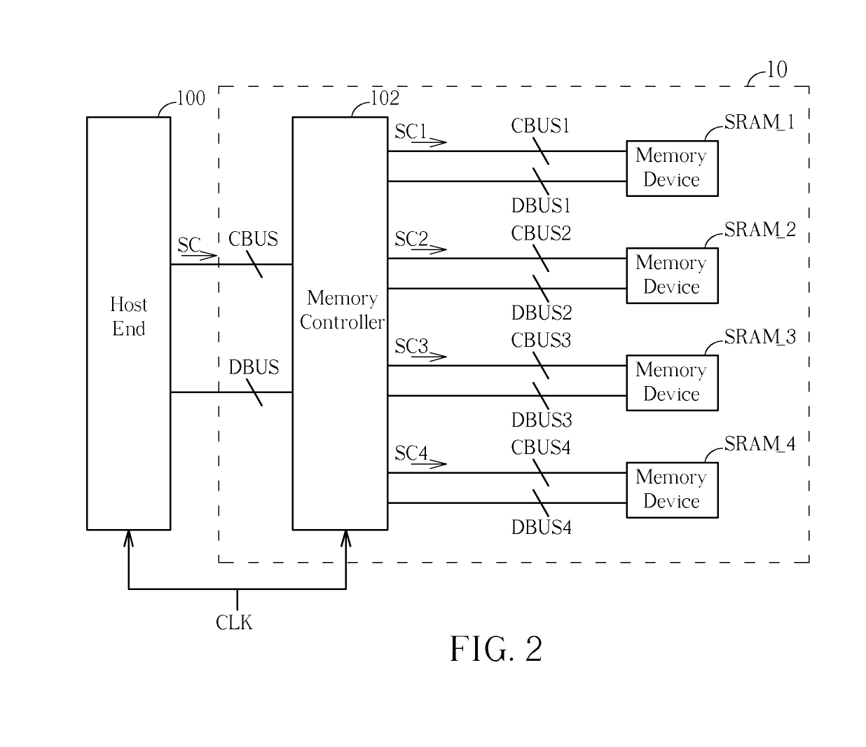

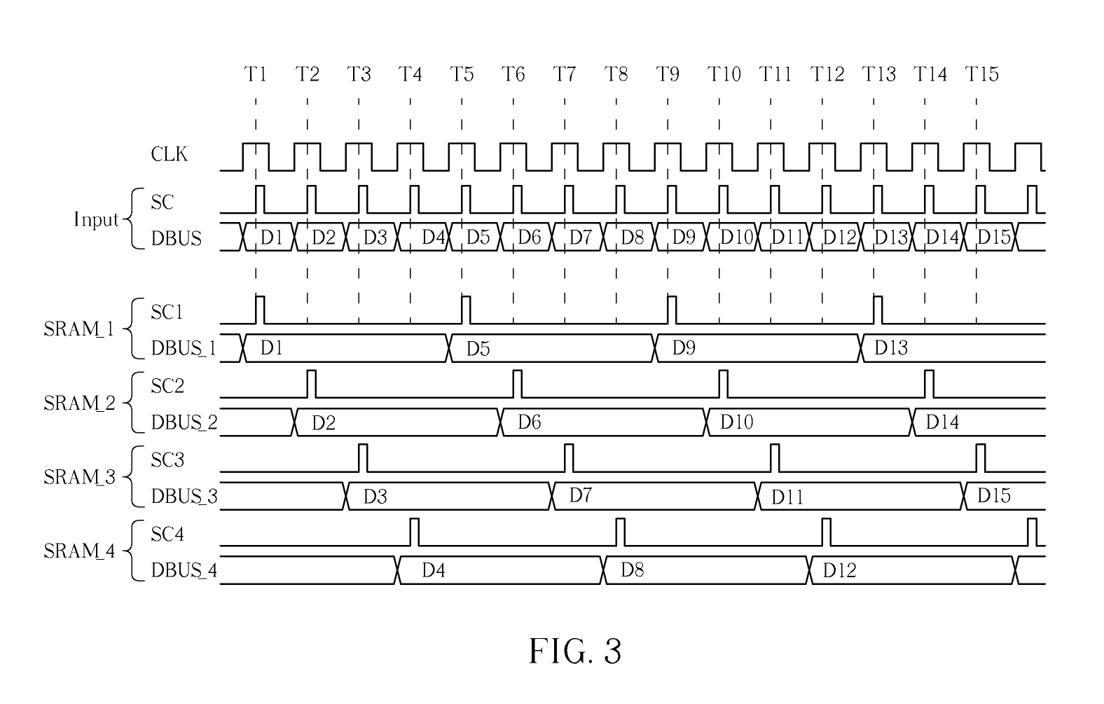

For an illustration of this, please refer to FIG. 2 and FIG. 3. FIG. 2 is a schematic diagram of the memory system 10 having four SRAM devices according to an embodiment of the present invention. FIG. 3 is a schematic diagram of signal waveforms of the memory system 10 shown in FIG. 2 during a writing operation according to an embodiment of the present invention. As shown in FIG. 2, supposing the operation frequency of the host end 100 is 4X MHz, the operation frequency of each of the memory devices SRAM_1˜SRAM_4 is X MHz. The system control bus CBUS, the system data bus DBUS, each of the control buses CBUS_1˜CBUS_4, and each of the data buses DBUS_1˜DBUS_4 all have a bus width of 8 bits. In such a condition, the memory system 10 can be applied to an image data signal with a pixel depth of 8 bits for representing 256 grayscale images. In FIG. 3, the signal waveforms from top to bottom are the system clock CLK, the system control signal SC of the system control bus CBUS, the system data bus DBUS, the control signal SC1 of the control bus CBUS_1, the data bus DBUS_1, the control signal SC2 of the control busCBUS_2, the data bus DBUS_2, the control signal SC3 of the control bus CBUS_3, data bus DBUS_3, the control signal SC4 of the control bus CBUS_4, and the data bus DBUS_4.

Please further refer to FIG. 3. The data package signals D1˜D15 are successively transmitted from the host end 100 to the memory controller 102 via the system data bus DBUS, and the memory controller 102 allots the received data package signals D1˜D15 into the memory devices SRAM_1˜SRAM_4 with time division multiplexing. Due to the higher operation frequency of the host end 100, as shown in FIG. 3, when the system data bus DBUS has transmitted four data package signals to the memory controller 102, each data bus only manages one writing operation for one data package signal. This means the memory system 10 can successively allot the received data package signals to each independent memory device in parallel. For example, when the data package signals are sequentially transmitted to the memory controller 102, the memory controller 102 controls the memory device SRAM_1 to store the data package signal D1 by using control signal SC1 at time T1. At time T2, the memory controller 102 controls the memory device SRAM_2 to store the data package signal D2 by using control signal SC2. In this way, the memory controller 102 receives the data signal transmitted from the host end 100 and distributes the received data signal to the memory devices SRAM_1˜SRAM_4 by turns in a time-sharing manner. That is, the memory controller 102 divides the operating time into several time slots and assigns the time slots to the memory devices SRAM_1˜SRAM_4 in turn. Therefore, each single memory device can store the corresponding data signal according to the assigned time slot. As a result, the memory system 10 can combine the memory devices SRAM_1˜SRAM_4 through the memory controller 102 to achieve 4X MHz data access for conforming to the data access requirement of the host end 100.

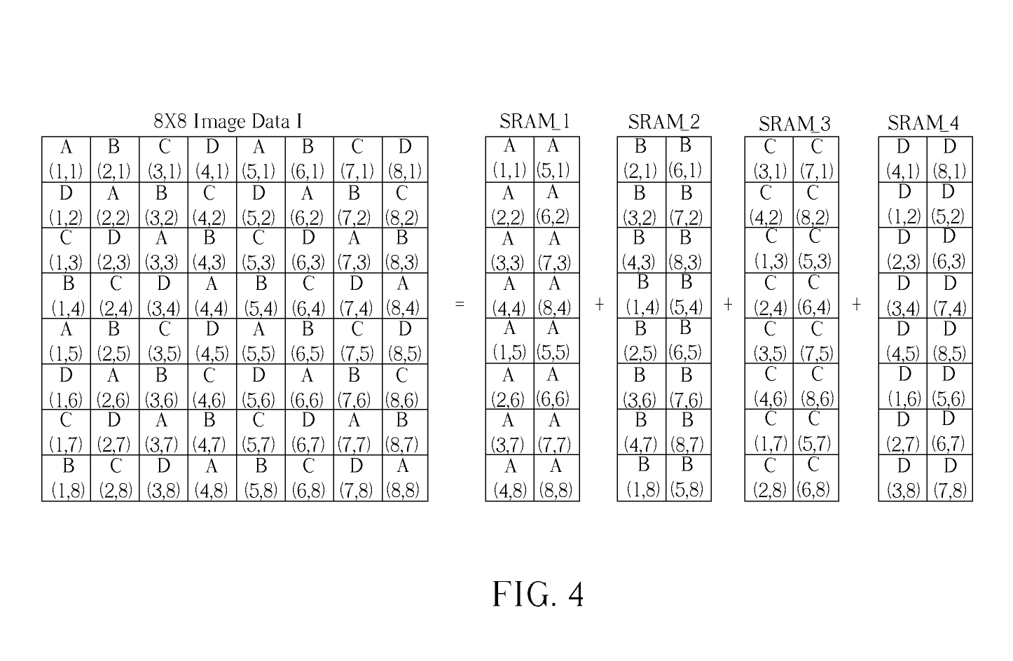

Please further refer to FIG. 4, which is a schematic diagram of image data configuration of the memory system 10 shown in FIG. 2 according to an embodiment of the present invention. Suppose the memory system 10 shown in FIG. 2 is utilized for registering an 8×8 pixels image data I in the graphic chip. As the image data usually takes a pixel as the unit, the image data can be accessed (written or read) in rows or columns. Therefore, when the image data I is applied in the memory system 10, the image data I can be transformed into an array address of each memory device through a re-mapping process. As shown in FIG. 4, each pixel data of the image data I can be allotted to the memory devices SRAM_1˜SRAM_4 equally. Since the host end 100 wants to store the image data I, the host end 100 can transmit the image data I to the memory controller 102 by rows or columns. After that, through the arrangement of the memory controller 102, the image data I can be stored into the memory devices SRAM_1˜SRAM_4 according to the mapping relation shown in FIG. 4. Similarly, when the host end 100 wants to read the image data I stored in the memory devices SRAM_1˜SRAM_4, the image data I can be read from the memory devices SRAM_1˜SRAM_4 according to the original mapping relation shown in FIG. 4 through the arrangement of the memory controller 102. Of course, the re-mapping type shown in FIG. 4 is only an exemplary embodiment of the present invention, and should not be taken as a limitation of the present invention. In addition, the writing operation of the memory system 10 shown in FIG. 2 to FIG. 4 is merely an exemplary embodiment of the present invention, and those skilled in the art can make alternations and modifications accordingly. For example, compared with the writing operation, the reading operation of the memory system 10 substitutes a reading data control operation for a storing data control operation for each memory device.

As can be seen, the present invention can realize the required data transmission bandwidth without changing the input/output transmission protocol specification. In addition, since the memory device with lower operation speed has a smaller leakage current effect, the present invention can combine several memory devices with lower operation speed through the allocation control of the memory controller for realizing a high bandwidth transmission memory system. As a result, the present invention can reduce system power consumption and realize high speed data access for high efficiency data transmission.

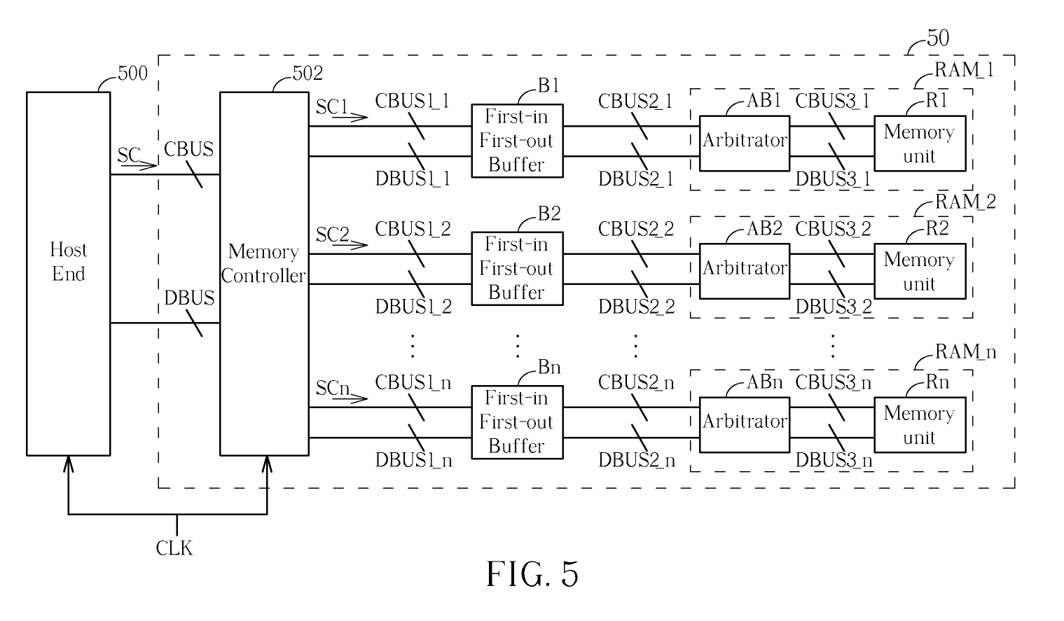

According to the operation principle of the memory system 10 shown in FIG. 1, the memory controller 102 can generate the corresponding control signal to each memory device. The memory controller 102, however, may transmit some read or write requests to a certain memory device with a high operation speed during a specific period. That is, for an independent memory device, the memory controller 102 allots two or more access requests for the independent memory device during a single read (or write) period. For example, as shown in FIG. 3, during the period of the time T1˜time T4, suppose there are two enable signals occurring at the control bus CBUS_1. In such a condition, the operation frequency of each independent memory device will not vary. All the received requests will be implemented after the corresponding operation periods. Thus, a data access error situation may occur due to the error implementation order. Please refer to FIG. 5, which is a schematic diagram of a memory system 50 according to a second embodiment of the present invention. Please note that elements of the memory system 50 shown in FIG. 5 with the same reference numerals as those in the memory system 10 shown in FIG. 1 have similar operations and functions and further description thereof is omitted for brevity. The interconnections of the units are as shown in FIG. 5. The memory system 50 includes a memory controller 502, a system control bus CBUS, a system data bus DBUS, first-in first-out buffers B1˜Bn, memory devices RAM_1˜RAM_n, control buses CBUS1_1˜CBUS1_n, control buses CBUS2_1˜CBUS2_n, data buses DBUS1_1˜DBUS1_n, and data buses DBUS2_1˜DBUS2_n. Different from the system shown in FIG. 1, first-in first-out buffers B1˜Bn are added between the memory controller 502 and the memory devices RAM_1˜RAM_n shown in FIG. 5. Therefore, in FIG. 5, when the memory controller 502 transmits several operation requests to a certain memory device during a specific period, the corresponding control signal can be provided to the corresponding memory device according to the first-in first-out order of the first-in first-out buffers B1˜Bn so as to prevent the access order error and therefore realize the high speed memory system of the present invention.

In addition, reading and writing operations of the memory device should be performed successively, and each memory device should operate independently without affecting or being affected by other devices. Therefore, as shown in FIG. 5, each memory device includes an arbitrator and a memory unit. The memory unit is utilized for realizing data read and store operations. Each arbitrator can connect to the corresponding memory unit via a control bus and a data bus and can also connect to the corresponding first-in first-out buffer to control the reading or writing operation of the corresponding memory unit according to the corresponding control signal.

Please note that the memory systems 10 and 50 are exemplary embodiments of the present invention, and those skilled in the art can make alternations and modifications accordingly. For example, during the read/write operation of the memory system, the host end can provide the address of the required data to the memory system for the following access process. The address data can be transmitted via an address bus or by sharing the common data bus or control bus, and this process is well known by those skilled in the art; the details of which are therefore not further explained herein for the sake of brevity.

In summary, the present invention can realize the required data transmission bandwidth without changing the input/output transmission protocol specification. Furthermore, the present invention can combine several memory devices with lower operation speed through the allocation control of the memory controller in a time-sharing manner for realizing a high bandwidth transmission memory system. As a result, the present invention can reduce system power consumption, enhance data bandwidth, and therefore realize high speed data access for high efficiency data transmission.

Those skilled in the art will readily observe that numerous modifications and alterations of the device and method may be made while retaining the teachings of the invention.

What is claimed is:

1. A high speed memory system, comprising:
a plurality of memory devices; and
a memory controller, coupled to the plurality of memory devices, for sequentially controlling access to the plurality of memory devices in a time-sharing manner according to a clock.

2. The high speed memory system of claim 1 further comprising:
a plurality of control buses, respectively coupled to the memory controller and the plurality of memory devices, for transmitting a plurality of control signals; and
a plurality of data buses, respectively coupled to the memory controller and the plurality of memory devices, for transmitting a plurality of data signals;
wherein the memory controller generates the plurality of control signals according to the clock, and the plurality of control signals are respectively transmitted to the plurality of memory devices via the plurality of control buses to control access to the plurality of memory devices.

3. The high speed memory system of claim 2 further comprising:
a system control bus, coupled to the memory controller, for transmitting a system control signal to the memory controller; and
a system data bus, coupled to the memory controller, for transmitting data signals.

4. The high speed memory system of claim 3, wherein bus width of each of the plurality of control buses is the same as the bus width of the system control bus.

5. The high speed memory system of claim 3, wherein bus width of each of the plurality of data buses is the same as the bus width of the system data bus.

6. The high speed memory system of claim 1, wherein the memory controller sequentially assigns a specific time period to each of the plurality of memory devices in a specific order according to a clock in order to control reading operation or writing operation for each of the plurality of memory devices.

7. The high speed memory system of claim 1, wherein each of the plurality of memory devices is a static random access memory.

8. A high speed memory system, comprising:
a plurality of memory devices;
a plurality of buffers, respectively coupled to the plurality of memory devices; and
a memory controller, coupled to the plurality of buffers, for generating a plurality of control signal to the plurality of buffers and sequentially controlling access to the plurality of memory devices in a time-sharing manner according to a clock.

9. The high speed memory system of claim 8 further comprising:
a plurality of first control buses, respectively coupled to the memory controller and the plurality of buffers;
a plurality of second control buses, respectively coupled to the plurality of buffers and the plurality of memory devices;
a plurality of first data buses, respectively coupled to the memory controller and the plurality of buffers; and
a plurality of second data buses, respectively coupled to the plurality of buffers and the plurality of memory devices, for transmitting a plurality of data signals;
wherein the memory controller generates the plurality of control signals according to the clock, and the plurality of control signals are respectively transmitted to the plurality of memory devices to control access to the plurality of memory devices.

10. The high speed memory system of claim 9 further comprising:
a system control bus, coupled to the memory controller, for transmitting a system control signal to the memory controller so that the memory controller controls access to the plurality of memory devices accordingly; and
a system data bus, coupled to the memory controller, for transmitting data signals.

11. The high speed memory system of claim 10, wherein each of the plurality of first control buses, each of the plurality of second control buses, and the system control bus have the same bus width.

12. The high speed memory system of claim 10, wherein each of the plurality of first data buses, each of the plurality of second data buses, and the system data bus have the same bus width.

13. The high speed memory system of claim 8, wherein each of the plurality of buffers is a first-in first-out buffer.

14. The high speed memory system of claim 8, wherein the memory controller sequentially assigns a specific time period to each of the plurality of memory devices in a specific order according to a clock in order to control a reading operation or writing operation for each of the plurality of memory devices.

15. The high speed memory system of claim 8, wherein each of the plurality of memory devices is a static random access memory.
